(19) United States
(12) Patent Application Publication
(10) Pub. No.: US 2002/0083144 A1
(43) Pub. Date: Jun. 27, 2002

(54) Method for remote control, system using the same method, and computer program product performing the same method

(76) Inventors: Hisakazu Kobayashi, Akashi-shi (JP); Norihiko Kumon, Shijonawate-shi (JP)

Correspondence Address: WENDEROTH, LIND & PONACK, L.L.P., 2033 K STREET N. W., SUITE 800, WASHINGTON, DC, 20006-1021, US

(21) Appl. No.: 09/842,188

(22) Filed: Apr. 26, 2001

(30) Foreign Application Priority Data
Dec. 13, 2000 (JP) 2000-378325

(51) Int. Cl. G06F 15/16

(52) U.S. Cl. 709/208; 709/224

(57) ABSTRACT

A system for remote control of host computer by client computer is disclosed. The client computer converts the operating procedure of its pointing device into operation information including data about switch operation, coordinates data, and time interval data between operations, and transmits the operation information to the host computer. The host computer decomposes the received operation information into the original operating procedure, and reproduces the original operating procedure. Thus, the operating procedure of the pointing device transmitted to the host computer is prevented from having effects of irregular delay of the network.

### FIELD OF THE INVENTION

The present invention relates to a remote control data processing method in a remote control system including a client computer, a host computer, and a network for linking them, system thereof, and a computer program product thereof.

### BACKGROUND OF THE INVENTION

Recently, as the communication network is expanded and computer systems mounting easy-to-use graphical user interface are developed, remote control systems for controlling electronic appliances at distant places through the network are widely distributing.

One of the problems of remote control by network is that it takes a certain time to transmit a remote control signal for a long distance. As a result, a time delay occurs between the local operation and operation at the distant place.

The delay time in network becomes a serious problem in the case of composite operations composed of plural operations. In composite operations, the interval of one operation and other is an important factor for judging what operation has been done. For example, suppose to open a computer program by double-clicking an icon on the screen of a computer in a distant place.

An example of a problem in remote control caused by delay time in the network is explained below.

FIG. 8 is a configuration of a remote control system.

In FIG. 8, the remote control system contains a client computer 2, a host computer 1 controlled by the client computer 2 from a distant place, and a network 3 linking these computers.

The host computer 1 comprises an information processing unit 11, a display unit 12, a communication unit 13, and a pointing device 14. The display unit 12 displays the image information processed in the information processing unit 11. The communication unit 13 exchanges information with the network 3. The pointing device 14 manipulates the host computer 1.

The client computer 2 comprises an information processing unit 21, a display unit 22, a communication unit 23, and a pointing device 24. The display unit 22 displays the image information processed in the information processing unit 21. The communication unit 23 exchanges information with the network 3. The pointing device 24 manipulates the client computer 2.

The pointing devices 14, 24 are a mouse, a digitizer, and other input devices.

The pointing devices 14, 24 have on/off buttons for moving the pointer for indicating a position on the screen of the display units 12, 22, and selecting the object indicated by the pointer by inputting coordinates data.

The user can click the on/off button twice quickly without moving the pointing device (without updating the device coordinates data), which is called a double click. In this case, if the interval between the first click and second click is long, this operation is not recognized as a double click.

The network 3 is a wired or wireless network such as a local area network (LAN) or a wide area network (WAN).

The operation of the remote control system is explained.

The host computer (hereinafter called host PC) 1 transmits the image information output in the display unit 12 to the communication unit 23 of the client computer (hereinafter called client PC) 2 from the communication unit 13 through the network 3. At this time, the client computer 2 processes the image information sent from the host computer 1 in the information processing unit 21, and outputs the image information to the display unit 22.

When the pointing device 24 is manipulated in the client PC 2, this operation information is sent to the communication unit 13 from the communication unit 23. The host PC 1 processes the operation information sent from the client PC 2 as the operation information by manipulation of the pointing device 14.

The host PC 1, when the image information output in the display unit 12 is changed by manipulation of the pointing device 14, sends the differential image information before and after the change from the first communication unit 13 to the communication unit 23 of the client PC 2.

The client PC 2 updates the image information in the display unit 22 according to the differential image information sent from the host PC 1.

In this manner, the host PC 1 located in a distant place can be operated from the client PC 2, and the same image information as in the display unit 12 of the host PC 1 can be shown in the display unit 22 of the client PC 2.

In this remote control system, if the delay time in the network is large, the following phenomena may occur.

i) If the double click entered in the client PC 2 is transmitted to the host PC 1 as operation information, it is not processed as a double click in the host PC 1.

ii) Two single clicks entered in the client PC 2 are processed as a double click at the host PC 1.

Such incorrect processes may occur if the time interval between packets is changed by an irregular delay characteristic of the network while the data of two packets showing two successive presses on the button of the pointing device 24 flow on the network. At this time, the host PC 1 recognizes and processes as if the button was pressed at different timing from the operation in transmission.

Moreover, as compared with the case of the user manipulating the host PC 1 directly, in case that the host PC 1 remote-controled by the client PC 2, it takes time until the input result at the client PC 2 is reflected in the first display unit 12 of the host side. Therefore, the user of the client computer 2 takes time until knowing that the double click is correctly entered at the host PC 1. As a result, the working efficiency drops.

### SUMMARY OF THE INVENTION

It is hence an object of the invention to present a method, system and a computer program product for processing remote control data even if the delay time in the network is large. In the invention, the host computer terminal and client computer terminal are coupled through the network, and the remote control system is built up.

The client computer terminal comprises:

an information processing unit,

a communication unit for exchanging information with the network, and

a pointing device for controlling the client computer terminal.

In this client computer terminal, the information processing unit transforms the operating procedure of the pointing device into the operation information including the button state data, coordinates data, and time interval data between the operations, and the communication unit sends the information to the network.

On the other hand, the host computer terminal comprises an information processing unit and a communication unit coupled with the network. In the host computer terminal, the information processing unit decomposes the operation information received in its communication unit into the operating procedure at the client terminal, and reproduces the operating procedure.

In this manner, the operating procedure of the pointing device at the client terminal can be reproduced at the host terminal without having effects of irregular delay of the network.

### BRIEF DESCRIPTION OF THE DRAWINGS

FIG. 1 shows a configuration of a remote control system in an embodiment of the invention.

FIG. 2A is a functional block diagram of information processing unit of client PC in the embodiment of the invention.

FIG. 2B is a functional block diagram of information processing unit of host PC in the embodiment of the invention.

FIG. 3 is a flowchart showing the first button ON judging process in a double click input of client PC in the embodiment of the invention.

FIG. 4 is a flowchart showing the first button OFF judging process after the first button ON in a double click input of the client PC in the embodiment of the invention.

FIG. 5 is a flowchart showing the second button ON judging process after the first button OFF in a double click input of the client PC in the embodiment of the invention.

FIG. 6 is a flowchart showing the process until advancing to the first button ON judging process in a double click input after the double click input or after going out of the double click input condition of the client PC in the embodiment of the invention.

FIG. 7 is a flowchart showing reception process of operation packet related to a pointing device of the client PC in the host PC in the embodiment of the invention.

FIG. 8 shows a configuration of a conventional remote control system.

### DESCRIPTION OF THE PREFERRED EMBODIMENT

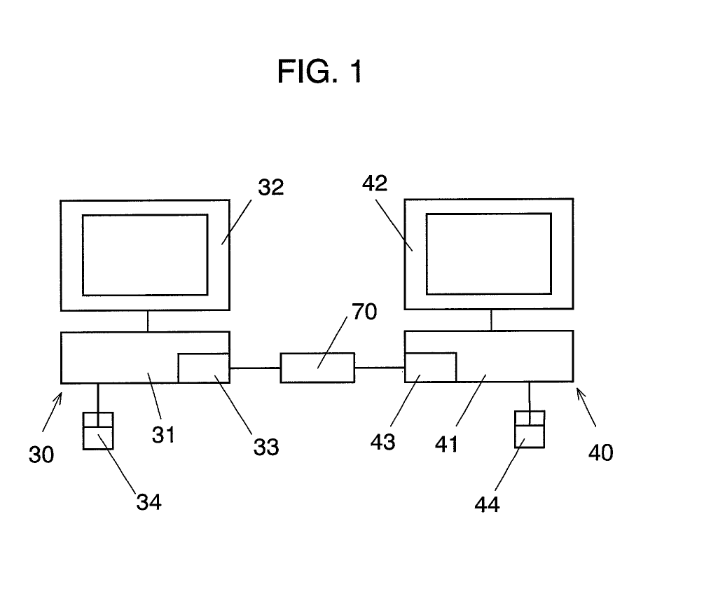

An embodiment of the invention is explained by referring to FIG. 1 to FIG. 7.

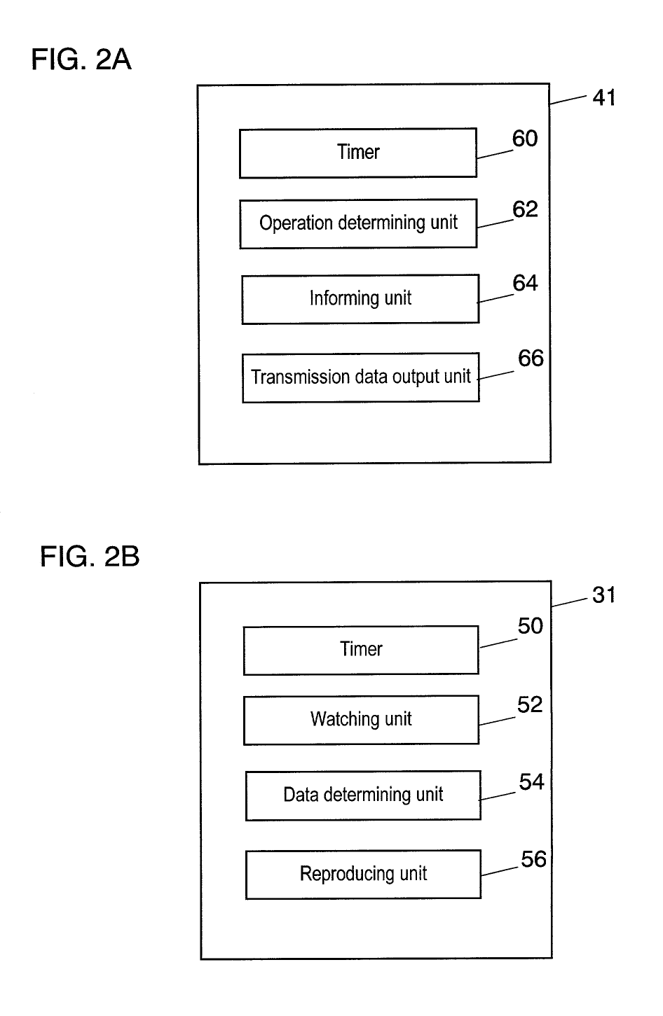

A configuration of remote control system in the embodiment is explained by referring to FIG. 1 and FIG. 2.

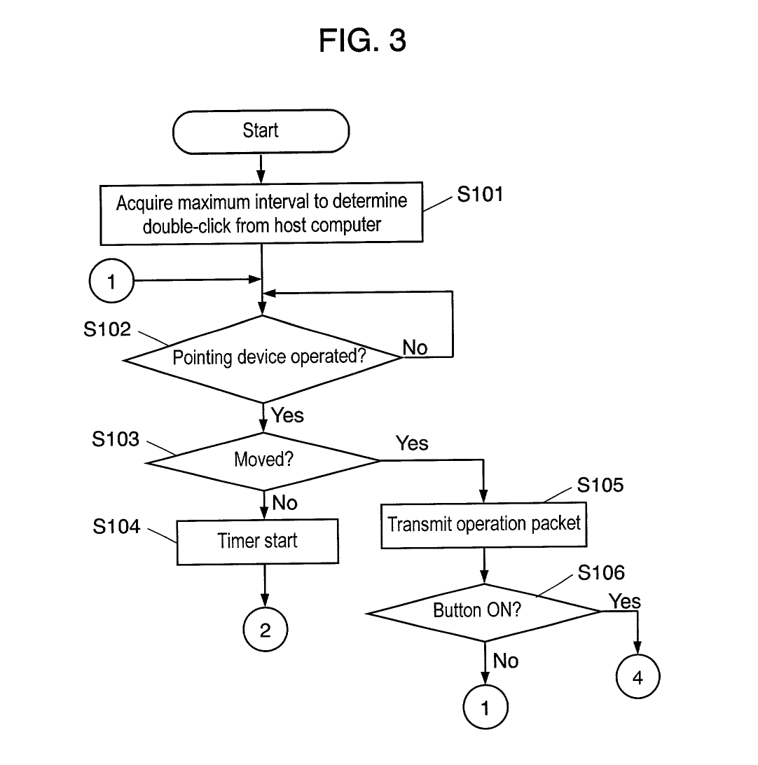

FIG. 3 to FIG. 6 are flowcharts showing the transmission process of operation packet about a pointing device 44 of the client computer in the embodiment.

In FIG. 1, information processing units 31, 41 monitor the operation of pointing devices 34, 44, respectively.

As the pointing device is manipulated, when the indicated coordinates are moved or the on/off of the button is changed, the processing units 31, 41 generate data, and display the coordinates data and the button status data on the screen of the display unit as a pointer. The processing units 31, 41 form data into packets, and send the data to the information processing unit of the partner of communication through communication units 33, 43 and network 70.

When the button of the pointing device is turned on, off and on within a maximum click interval T1 without change in the coordinates indicated by the pointing device, the processing units 31, 41 judge an input of double click.

The processing units 31, 41 have a timer for measuring the maximum click interval T1.

The timer has a function like a watchdog timer, and measures the time from a first click to a second click on the pointing device. The timer setting time T1 is counted from 0 second, and is the duration from the start at an arbitrary timing until the end.

FIG. 2A is a functional block diagram showing the operation of the information processing unit 41 of the client PC 40.

FIG. 2B is a functional block diagram showing the operation of the information processing unit 31 of the host PC 30.

In FIG. 2A, a timer 60 counts the time as the reference for detecting the operation of the pointing device 44. An operation determining unit 62 detects and judges the move of the pointing device 44 and on/off operation of its button. On the basis of result of this detection and judgement, the operation determining unit 62 further generates operation information. This operation information includes the coordinates data showing the move of the pointing device 44, button status data showing the on/off operation of the button, and the time between the operations. An informing unit 64 outputs data for informing the user of the operation of the pointing device. A transmission data output unit 66 outputs the data about the operation of the pointing device including the operation information to the network 70 through the communication unit 43.

In FIG. 2B, a timer 50 counts the time for judging a double click of the pointing device 34 at the host PC 30. A watching unit 52 monitors the reception of data about the operation of the pointing device including the operation information sent from the client PC. A data determining unit 54 judges the operation of the pointing device at the client PC 40 based on the data including the operation information sent from the client PC 40. A reproducing unit 56 reproduces the operation of the pointing device at the client PC 40 depending on the data judged by the data determining unit 54 at the host PC 30.

The operation in the client PC 40 is explained by referring to FIG. 3 to FIG. 6.

The remote control data processing in the client PC 40 includes the following processing in the input of double click.

1) Judging the first button ON,

2) Judging the first button OFF after the first button ON,

3) Judging the second button ON after the first button OFF, and

4) Processing before advancing to the first button ON judging process in a double click input, after the double click input or after going out of the double click input condition.

The procedure is explained sequentially from the flowchart in FIG. 3.

FIG. 3 is a flowchart showing the first button ON judging process in a double click input in the client PC 40.

In FIG. 3, at the click interval acquiring step S101, the timer 60 acquires the maximum click interval T1 for judging a double click from the host PC 30.

At the first watching step S102, the operation determining unit 62 judges if the client side pointing device 44 has been operated or not. If not operated, the watching step continues until the operation is recognized. When the device 44 is operated, the process goes to the first move judging step S103.

At step S103, the determining unit 62 judges if the operation of the pointing device 44 is accompanied by a move or not. If not moved, it is regarded that the button of the device 44 is turned on, and the process goes to the first timer start step S104. If moved, the process goes to the first operation packet transmit step S105.

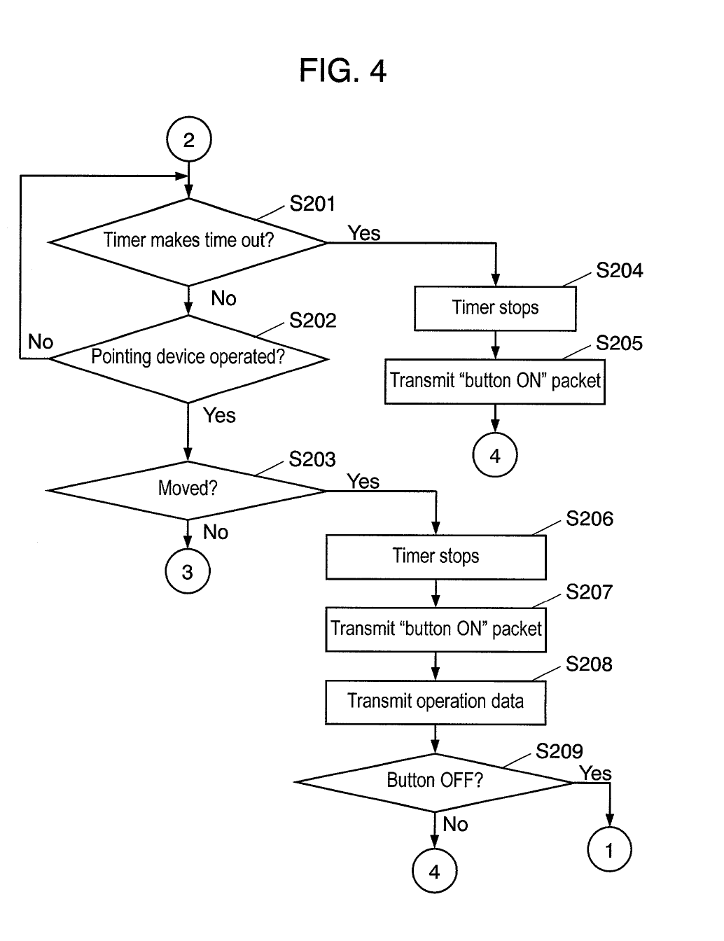

At step S104, the timer 60 starts, and the flowchart in FIG. 4 is started.

At step S105, the data output unit 66 sends a coordinates data packet showing the move operation generated in the operation determining unit 62 to the host 30. After transmission, the process goes to the first ON judging step S106.

At step S106, the determining unit 62 judges if the button of the pointing device 44 has been turned on or not.

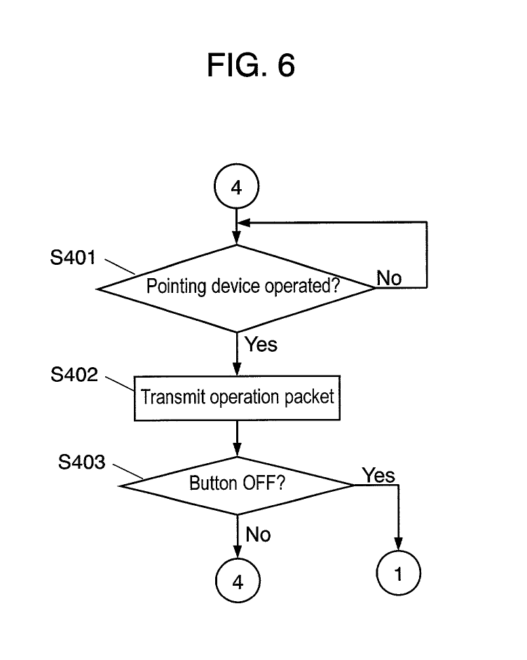

If the button is turned on, the flowchart in FIG. 6 is started.

If the button is not turned on, going back to step S102, the same process is repeated.

The flowchart in FIG. 4 is explained.

FIG. 4 is a flowchart showing the first button OFF judging process after first button ON in double click input in the client computer 40.

At the first lapse time measuring step S201, the timer 60 measures the lapse time, and judges if the time has exceeded T1 or not. When exceeding T1, the process goes to the first timer stop step S204. Otherwise, the process goes to the second watching step S202.

At step 202, the determining unit 62 judges if the pointing device 44 is operated or not. If the device 44 is not operated, going back to step S201, the timer continues to watch until exceeding time T1.

When operated, the process goes to the second move judging step S203.

At step S203, it is judged if the operation of the pointing device 44 is accompanied by a move or not.

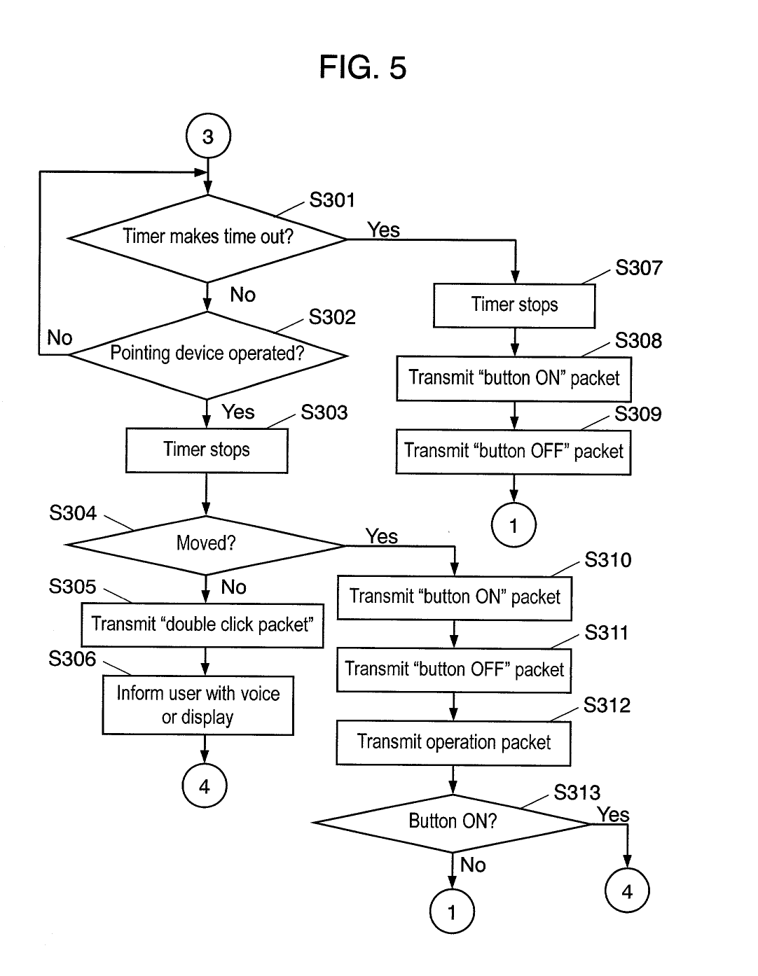

If not moved, the determining unit 62 judges that the device 44 is turned off, and the flowchart in FIG. 5 is started.

If moved, it is regarded that the device 44 is moved with the button remaining in ON position, and the process goes to the second timer stop step S206.

At step S206, the timer 60 stops, and the output unit 66 transmits the packet data showing button ON to the host PC 30 through the communication unit 43 (the second ON packet transmit step S207).

In succession, the coordinates data packet of the device 44 is sent to the host PC 30 (the second operation packet send step S208).

After transmission, the process goes to the first OFF judging step S209.

At step S209, the determining unit 62 judges if the ON state button is manipulated to the OFF state or not.

If the button is manipulated to OFF state, going back to step S102 in FIG. 1, the same process is repeated.

When the button remains in ON position, the flowchart in FIG. 6 is started.

At the first timer stop step S204, the timer 60 stops, and the process goes to first ON packet send step S205.

At step S205, the output unit 66 transmits the button ON packet data to the host PC 30, and the flowchart in FIG. 6 is started.

The steps in the flowchart in FIG. 5 are explained.

FIG. 5 is a flowchart showing the second button ON judging process after first button OFF in a double click input in the client PC 40.

At the second lapse time measuring step S301, the timer 60 measures the lapse time, and judges if the time has exceeded T1 or not. When exceeding T1, the process goes to the fourth timer stop step S307. Otherwise, the process goes to the third watching step S302.

At step 302, the determining unit 62 judges if the second pointing device 44 is operated or not. If the device 44 is not operated, going back to step S301, the timer continues to watch until exceeding time T1 When operated, the process goes to the third timer stop step S303.

At step S303, the timer 60 stops, and the process goes to the third move judging step S304.

At step S304, the determining unit 62 judges if the operation of the pointing device 44 of the client PC 40 is accompanied by a move or not.

If not moved, the determining unit 62 judges that the device 44 is turned off. At this time, the output unit 66 transmits an operation command showing a double click to the host PC 30 (double click send step S305).

Consequently, the informing unit 64 transmits data to an audio output unit or a video output unit of the client PC 40 to inform the user of transmission of double click command by voice or display (informing step S306).

The next process goes to step S401 in FIG. 6.

If the pointing device 44 is moved by operation, on the other hand, the determining unit 62 judges that the button is turned on (step S102), and then turned off (step S202), and consequently that the device 44 is moved. Therefore, first, the output unit 66 transmits packet data showing button ON to the host PC 30 (fourth ON packet send step S310).

Next, the output unit 66 transmits packet data showing button OFF to the host computer 30 (fourth OFF packet send step S311).

Further, the output unit 66 transmits the coordinates data showing the coordinates of the moved position of the device 44 to the host computer 30 (third operation packet send step S312). Then the process goes to the third ON judging step S313.

At the second lapse time measuring step S301, when the lapse time of the timer 60 exceeds T1, the process goes to the fourth timer stop step S307.

At step S307, the timer 60 stops, and the process goes to the third ON packet transmit step S308.

At step S308, the output unit 66 transmits the packet data showing an button ON to the host PC 30, and the process goes to third OFF packet send step S309.

At step S309, the output unit 66 transmits the packet data showing an button OFF to the host PC 30, and the process returns to step S102 in FIG. 1.

At the third ON judging step S313, the operation determining unit 62 judges if the operation judged at step S302 is ON operation of button or not.

In the case of ON operation of button, the process goes to the fourth watching step S401 in FIG. 6.

Otherwise, the process returns to step S102 in FIG. 1.

The flowchart in FIG. 6 is explained.

FIG. 6 is a flowchart showing the process until advancing to the first button ON judging process in a double click input after the double click input or after going out of the double click input condition in the client PC 40.

At the fourth watching step S401, the determining unit 62 judges if the second pointing device 44 is operated or not. If not operated, watching continues until operation is recognized.

When the device 44 is operated, the process goes to the fourth operation packet send step S402.

At step S402, the output unit 66 transmits the operation packet showing the operation judged at step S401 to the host computer 1, and the process goes to the fourth OFF judging step S403.

At step S403, the determining unit 62 judges if the operation judged at step S401 is OFF operation of button or not.

In the case of OFF operation of button, the process returns to step S102 in FIG. 1.

Otherwise, the process returns to step S401.

Thus, in the information processing unit 41, the operation determining unit 62 judges the operation of the pointing device 44, and generates operation information as packet data. The data output unit 66 outputs the operation information as packet data to the network 70 through the communication unit 43.

Process of remote control data in the host PC 30 is explained below.

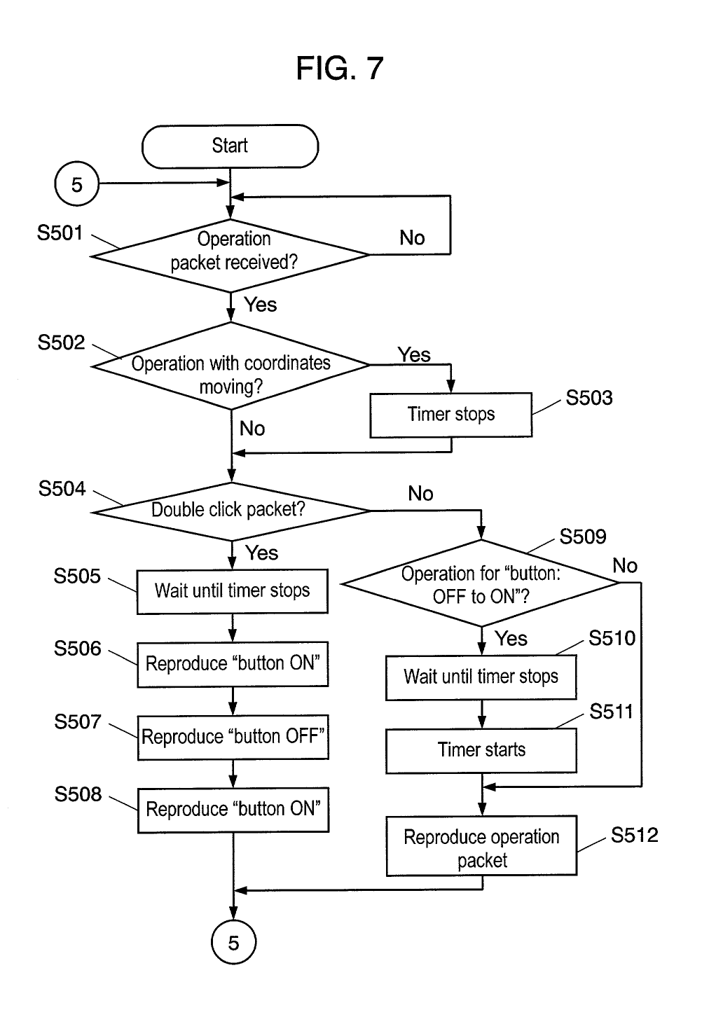

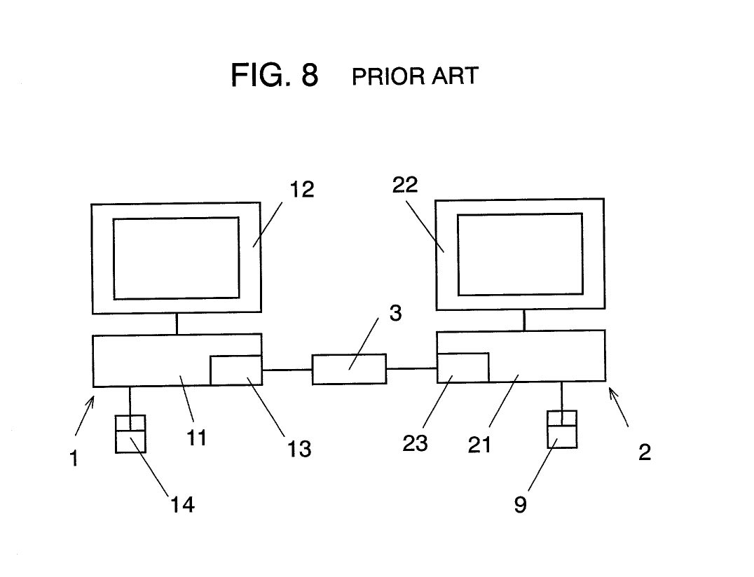

FIG. 7 is a flowchart showing reception process of operation packet, that is, operation information about the pointing device 44 of the client PC 40 in the host PC 30 in the embodiment.

Herein, T2 is the maximum click interval for judging a double click by button ON-OFF-ON operation of the pointing device 34 in the host PC 30. The timer 50 stops automatically when exceeding the time T2.

In FIG. 7, at reception watching step S501, the watching unit 52 judges if the operation packet data transmitted from the client computer 40 is received or not.

If not received, the watching unit 52 continues to monitor until the reception is confirmed.

When received, the process goes to the fourth move judging step S502.

At step S502, the data determining unit 54 judges if the operation packet data received at step S501 shows the operation accompanied by move of the pointing device 44 of the coordinates or not.

If accompanied by move of coordinates, the process goes to the fourth timer stop step S503. At this step, the timer 50 stops, and the process goes to the double click judging step S504.

If not accompanied by move, the process goes to step S504.

At step S504, the data determining unit 54 judges if the operation packet data received at step S501 shows a double click or not.

If the data shows a double click, the process goes to the first timer operation watching step S505.

If the data does not show a double click, the process goes to the button operation judging step S509.

At the first timer operation watching step S505, the watching unit 52 judges if the timer is in operation or not. If in operation, the unit waits until stopping automatically. Then, the reproducing unit 56, after the first ON reproducing step S506, the OFF reproducing step S507, and the second ON reproducing step S508, reproduces the ON-OFF-ON operation of the button of the pointing device 14 so as to be recognized as a double click in the host PC 30.

If judged not to be a double click at step S504, the process goes to the button operation judging step S509.

At step S501, the data determining unit 54 checks if the received operation packet shows the operation of changing the button of the pointing device from ON to OFF or not. If Yes, the process goes to the second timer operation watching step S510. Otherwise, the process goes to the operation packet reproducing step S512 for reproducing the button operation.

At the second timer watching step S510, the data determining unit 54 judges if the timer is in operation or not. During operation, waiting until stopping automatically, the process goes to the second timer start step S511.

At step S511, the timer 50 starts, and the process goes to the operation packet reproducing step S512.

At step S512, the reproducing unit 56 reproduces the operation indicated by the operation packet received at step S501.

Thus, in the information processing unit 31, the data determining unit 54 judges the operation of the pointing device in the client PC by the data including the operation information sent from the client PC 40. The reproducing unit 56 reproduces the operation of the pointing device in the client PC at the host PC 30 depending on the data judged by the data determining unit 54.

According to the embodiment of the invention, the double click is transmitted from the client computer to the host computer, not as the plural operation packets showing on/off operation of the button, but as one operation packet showing the double click. Therefore, even if the delay time of the network is large, the host computer correctly recognizes the input of double click at the client computer.

Moreover, the transmission of operation packet showing a double click input from the client computer to the host computer is noticed to the user of the client computer by voice or display. Thus, the user instantly understands the input of double click.

As described herein, in the remote control data processing method and system of the invention, the information processing unit of the client computer converts the operating procedure of the pointing device into operation information including button status data, coordinates data, and interval data between operations, and transmits the operation information to the host computer. In the information processing unit at the host computer, the operating procedure is reproduced from the received operation information. Thus, even if the delay time of the network is large, the host computer correctly recognizes the operation entered in the client computer.

In the foregoing embodiment, the specific method and device are explained. The invention may be also realized by using a computer program product containing a computer program for executing the method shown in the embodiment by a computer.

What is claimed is:

1. A computer terminal device coupled to another computer terminal device through a network comprising:
i) an information processing unit,
ii) a communication unit for exchanging information with the network, and
iii) a pointing device for controlling said computer terminal device,
wherein said information processing unit converts an operating procedure of the pointing device into operation information including operation data, coordinates data, and time interval data between operations, and said communication unit transmits the operation information to the network.

2. The computer terminal device of claim 1,
wherein said communication unit transmits the operation information by wireless means.

3. The computer terminal device of claim 1,
wherein transmission of the operation information is noticed to the user.

4. The computer terminal device of claim 1,
wherein said information processing unit comprises operation determining means for judging whether the operation of the pointing device is single click or double click, and a transmission data output unit, and when said operation determining means judges double click, said transmission data output unit outputs the operation information including the information showing double click to the communication unit.

5. The computer terminal device of claim 4,
wherein said information processing unit further comprises a timer, and said timer sets the time interval of two single clicks for the operation determining means for judging two single clicks as double click.

6. A host computer terminal device coupled to a computer terminal through a network comprising:
i) an information processing unit, and
ii) a communication unit coupled to the network,
wherein said information processing unit decomposes operation information including operation data, coordinates data, and time interval data between operation showing an operating procedure of the pointing device of the computer terminal received by the communication unit into the operating procedure.

7. The host computer terminal device of claim 6,
wherein said communication unit receives the operation information by wireless means.

8. The host computer terminal device of claim 6,
wherein said information processing unit comprises reproducing means, and said reproducing means reproduces two single clicks when the information processing unit receives the operation information showing double click.

9. The host computer terminal device of claim 6,
wherein said information processing unit comprises data determining unit, and said data determining unit judges single click when receiving the operation information showing single click.

10. A remote control system through a network comprising:
a) a first computer terminal, and
b) a second computer terminal coupled through the network,
wherein said first computer terminal comprises:
i) a first information processing unit,
ii) a first communication unit for exchanging information with the network, and
iii) a pointing device for controlling said first computer terminal,
said information processing unit converts an operating procedure of the pointing device into operation information including operation data, coordinates data, and time interval data between the operation, and said first communication unit transmits the operation information to the network,
said second computer terminal comprises:
a) a second information processing unit, and
b) a second communication unit coupled to the network, and
said second information processing unit decomposes the operation information received by said second communication unit into the operating procedure.

11. A remote control method of another computer terminal at a computer terminal coupled to said another computer terminal through a network, comprising the steps of
a) acquiring a specified maximum click interval,
b) detecting an operation of a pointing device by the input status and coordinates data,
c) measuring the lapse time when a value of the coordinates data remains at a same value while a button of the pointing device is in ON status,
d) monitoring the operating state of the pointing device to check if the lapse time exceeds the maximum click interval or not,
e) judging the lapse time, the input status, and the coordinates data when the pointing device is operated next time,
f) monitoring the operating state of the pointing device to check if the lapse time exceeds the maximum click interval or not, when the lapse time does not exceed the maximum click interval, the input status is changed from ON to OFF, and the coordinates data remains at the same value,
g) detecting the lapse time, the input status and the coordinates data when the pointing device is operated next time,
h) judging double click is made when the lapse time does not exceed the maximum click interval, the button is changed from OFF to ON, and the coordinates data remains at the same value, and
i) transmitting the operation information showing the double click to the network.

12. The remote control method of claim 11,
wherein transmission of composite operation information is further noticed to the user at step i).

13. A remote control method from another computer terminal at a computer terminal coupled to said another computer terminal through a network, comprising the steps of:
a) monitoring the received operation information of said another computer terminal,
b) judging whether the operation information is received or not,
c) judging if the operation information includes data showing double click or not, and
d) reproducing as double click operation at the computer terminal if the operation information includes data showing double click.

14. A computer program product for remote control of another computer terminal coupled to a computer terminal through a network, comprising the steps of
a) acquiring a predetermined maximum click interval,
b) detecting an operation of a pointing device by the input status and the coordinates data,
c) measuring a lapse time when the value of the coordinates data remains at a same value while a button of the pointing device is in ON status,
d) monitoring an operating state of the pointing device to check if the lapse time exceeds the maximum click interval or not,
e) judging the lapse time, the input status, and the coordinates data when the pointing device is operated next time,
f) monitoring the operating state of the pointing device to check if the lapse time exceeds the maximum click interval or not, when the lapse time does not exceed the maximum click interval, the input status is changed from ON to OFF, and the coordinates data remains at the same value,
g) detecting the lapse time, the input status and the coordinates data when the pointing device is operated next time,
h) judging double click is made when the lapse time does not exceed the maximum click interval, the button is changed from OFF to ON, and the coordinates data remains at the same value, and
i) transmitting the operation information showing double click to the network.

15. The computer program product of claim 14,
wherein transmission of composite operation information is further noticed to the user at step i).

16. A computer program product for remote control from another computer terminal at a computer terminal coupled to said another computer terminal through a network, comprising the steps of
a) monitoring the received operation information of said another computer terminal,
b) judging whether the operation information is received or not,
c) judging if the operation information includes data showing double click or not, and
d) reproducing as double click operation at the computer terminal if the operation information includes data showing double click.
